(19) United States
(12) Patent Application Publication
(10) Pub. No.: US 2002/0094382 A1
(43) Pub. Date: Jul. 18, 2002

(54) Method of forming conductive pattern

(75) Inventors: Genji Imai, Hiratsuka-shi (JP); Daisuke Kojima, Hiratsuka-shi (JP)

Correspondence Address: ARMSTRONG,WESTERMAN & HATTORI, LLP, 1725 K STREET, NW., SUITE 1000, WASHINGTON, DC, 20006, US

(73) Assignee: KANSAI PAINT CO., LTD., Amagasaki-shi (JP)

(21) Appl. No.: 09/988,252

(22) Filed: Nov. 19, 2001

(30) Foreign Application Priority Data
Dec. 1, 2000 (JP) 2000-366532

(51) Int. Cl. B05D 1/32; B05D 3/06

(52) U.S. Cl. 427/282; 427/558; 427/510

(57) ABSTRACT

The present invention provides a method of forming a conductive pattern, comprising the steps of: (1) applying a positive, energy-sensitive paste composition containing a conductive powder to a substrate, followed by drying, to form a positive, energy-sensitive coating, (2) irradiating the coating with active energy rays or heat rays directly or through a mask so as to obtain a desired pattern, and (3) removing the irradiated part of the coating by development to form a conductive pattern coating; and a method of forming a conductive pattern, wherein the above paste composition is applied to a release film and dried, and using the resulting dry film, a conductive pattern coating is formed in a manner similar to the above.

### FIELD OF THE INVENTION

The present invention relates to a novel method of forming a conductive pattern.

### BACKGROUND OF THE INVENTION

Photolithography has been conventionally used for forming conductive patterns on, for example, plastic substrates or inorganic substrates, in production processes of wiring boards, display panels, etc.

Japanese Unexamined Patent Publication No. 1997-304923 discloses a method of forming a conductive pattern, which comprises the steps of: applying to a substrate a negative photosensitive paste composition comprising an unsaturated double bond-containing photosensitive compound, fine particles of conductive metal, a polymerization initiator and a glass frit, to form a photosensitive conductive coating; irradiating the surface of the coating with visible light to cure the irradiated part; removing the unirradiated (uncured) part of the coating by development to obtain a desired conductive pattern; and carrying out calcination.

However, the above method has the drawback that, when the photosensitive conductive coating is irradiated with visible light, the degree of curing differs between the surface and the inner portion of the coating. Thus, in the development step, a larger amount of the coating is dissolved and removed at portions closer to the substrate (where the degree of curing is low) than at portions closer to the surface (where the degree of curing is high). Accordingly, the precision of the resulting conductive pattern is reduced. This phenomenon will be explained referring to schematic diagrams: As shown in FIG. 2(a), the conductive pattern coating formed by the above method has a cross section which gradually decreases from the surface toward the substrate. The coating, when calcined, is warped as shown in FIG. 2(b) and thus the resulting wiring circuit or the like is deformed. In FIG. 2, the numerals indicate the following: 1, substrate; 2, conductive pattern coating before calcination; 3, conductive pattern coating after calcination.

### DISCLOSURE OF THE INVENTION

An object of the present invention is to provide a novel method of forming a conductive pattern.

Other objects and features of the present invention will become apparent from the following description.

The present invention provides the following methods for forming conductive patterns.

1. A method of forming a conductive pattern, comprising the steps of:

(1a) applying a positive, energy-sensitive paste composition containing a conductive powder to a substrate, followed by drying, to form a positive, energy-sensitive coating;

(2a) irradiating the coating with active energy rays or heat rays directly or through a mask so as to obtain a desired pattern; and

(3a) removing the irradiated part of the coating by development to form a conductive pattern coating.

2. A method according to Item 1, wherein the positive, energy-sensitive paste composition is a positive, visible light-sensitive paste composition.

3. A method according to Item 1, wherein the positive, energy-sensitive paste composition is a positive, ultraviolet-sensitive paste composition.

4. A method according to Item 1, wherein the positive, energy-sensitive paste composition is a positive thermosensitive paste composition.

5. A method according to Item 1, wherein the positive, energy-sensitive paste composition further contains a heat-fusible inorganic powder and wherein calcination is carried out after Step (3a).

6. A method according to Item 5, wherein the heat-fusible inorganic powder is a glass frit.

7. A method of forming a conductive pattern, comprising the steps of:

(1b) applying a positive, energy-sensitive paste composition containing a conductive powder to a surface of release film, followed by drying, to form a dry film having a positive, energy-sensitive layer;

(2b) superimposing the dry film onto a substrate in such a manner that the surface of the positive, energy-sensitive layer is in contact with the substrate, to form a positive, energy-sensitive coating, and then peeling off the release film;

(3b) irradiating the coating with active energy rays or heat rays directly or through a mask so as to obtain a desired pattern; and

(4b) removing the irradiated part of the coating by development to form a conductive pattern coating.

8. A method according to Item 7, wherein the positive, energy-sensitive paste composition is a positive, visible light-sensitive paste composition.

9. A method according to Item 7, wherein the positive, energy-sensitive paste composition is a positive, ultraviolet-sensitive paste composition.

10. A method according to Item 7, wherein the positive, energy-sensitive paste composition is a positive thermosensitive paste composition.

11. A method according to Item 7, wherein the positive, energy-sensitive paste composition further contains a heat-fusible inorganic powder and wherein calcination is carried out after Step (4b).

12. A method according to Item 11, wherein the heat-fusible inorganic powder is a glass frit.

13. A method of forming a conductive pattern, comprising the steps of:

(1c) applying a positive, energy-sensitive paste composition containing a conductive powder to a surface of release film, followed by drying, to form a dry film having a positive, energy-sensitive layer;

(2c) superimposing the dry film onto a substrate in such a manner that the surface of the positive, energy-sensitive layer is in contact with the substrate, to form a positive, energy-sensitive coating;

(3c) irradiating the coating with active energy rays or heat rays through the release film with or without a mask so as to obtain a desired pattern; and

(4c) peeling off the release film, and removing the irradiated part of the coating by development to form a conductive pattern coating.

14. A method according to Item 13, wherein the positive, energy-sensitive paste composition is a positive, visible light-sensitive paste composition.

15. A method according to Item 13, wherein the positive, energy-sensitive paste composition is a positive, ultraviolet-sensitive paste composition.

16. A method according to Item 13, wherein the positive, energy-sensitive paste composition is a positive, thermosensitive paste composition.

17. A method according to Item 13, wherein the positive, energy-sensitive paste composition further contains a heat-fusible inorganic powder and wherein calcination is carried out after Step (4c).

18. A method according to Item 17, wherein the heat-fusible inorganic powder is a glass frit.

The present inventors carried out extensive research to overcome the drawbacks of the prior art, and found that these drawbacks can be overcome by forming a conductive pattern using a positive, energy-sensitive paste composition containing a conductive powder and optionally a heat-fusible inorganic powder.

In the method of the invention, when a coating formed from the positive, energy-sensitive paste composition is irradiated with energy rays, the degree of decomposition of the coating differs between the surface and the inner portion of the coating. Thus, in the development step, a larger amount of coating is dissolved and removed at portions closer to the surface (where the degree of decomposition is high) than at portions closer to the substrate (where the degree of decomposition is low). As a result, a highly precise pattern can be obtained. This phenomenon will be explained referring to schematic diagrams: As shown in FIG. 1 (a), the conductive pattern coating has a cross section which gradually decreases from the substrate toward the surface. When the coating is calcined, a pattern coating can be obtained which is free from warping as shown in FIG. 1 (b). Thus, the resulting wiring circuit or the like has high precision. In FIG. 1, the numerals indicate the following: 1, substrate; 2, conductive pattern coating before calcination; 3, conductive pattern coating after calcination.

The present invention has been accomplished based on these novel findings.

Positive, Energy-Sensitive Paste Composition

The positive, energy-sensitive paste composition for use in the method of the invention is a paste prepared by adding a conductive powder to a known positive, energy-sensitive composition.

The conductive powder for use in the paste composition may be a powder of known conductive material. Examples of conductive materials include, silver, copper, iron, manganese, nickel, aluminium, cobalt, chromium, lead, zinc, bismuth, ITO and like metals, alloys of at least one of these metals, and oxides of these metals or alloys. Also usable are insulating materials having a coating or deposited layer of any of these conductive materials. Further, the conductive powder may be a powder of any conductive material other than metals, such as a conductive polymer.

The conductive powder may be an antimony-doped tin dioxide powder, which is prepared by doping semi-conductive tin dioxide with antimony to form a donor level of electrons and thereby increase the conductivity. The antimony-doped tin dioxide powder can be used singly, or as a coating on another inorganic material. The inorganic material to be coated with the antimony-doped tin dioxide may be, for example, titanium oxide, potassium titanate, aluminum borate, barium sulfate, mica, silica or the like.

A suitable average particle size of the conductive powder is usually about 0.001 to 100 μm, preferably 0.01 to 30 μm.

The conductive powder is used in a proportion of 10 to 90 wt. %, preferably 50 to 80 wt. % in the composition.

It is preferable that the paste composition of the invention further contain a heat-fusible inorganic powder, to improve the adhesion to a substrate.

The heat-fusible inorganic powder for use in the paste composition of the invention may be, for example, a glass frit. Use of a glass frit increases adhesion of a coating of the composition to a substrate, in particular a glass substrate.

When the composition is to be calcined on a glass electrode substrate of a plasma display or the like, the glass frit contained in the composition preferably has a low glass transition temperature (Tg) and a low glass softening point (Ts). For example, it is desirable that the glass frit have a Tg of 300 to 500° C. and a Ts of 350 to 450° C. A glass frit having a Tg less than 300° C. is not preferable since it starts sintering before the resin or other organic components evaporate from the composition. More preferably, the glass frit has a Tg of 350 to 450° C.

A suitable average particle size of the glass frit is usually about 0.1 to 100 μm, preferably 0.5 to 20 μm.

The glass frit is used preferably in a proportion of 1 to 10 wt. % in the composition. A smaller proportion of glass frit is desirable in order to decrease the resistance of glass electrodes in a plasma display or the like. However, if the proportion of glass frit is not greater than 1 wt. %, it is difficult to achieve strong adhesion between an electrode membrane and a glass substrate. On the other hand, since glass frits are electrically insulative, use of more than 10 wt. % of glass frit increases the resistance of electrodes or the like, which is undesirable. The proportion of glass frit is more preferably 1 to 5 wt. % in the composition.

The positive, energy-sensitive composition into which a conductive powder and optionally a heat-fusible inorganic powder are incorporated may be any known composition capable of forming a coating which is decomposed when irradiated with ultraviolet rays, visible light, heat rays or like energy rays and thereby changed in solubility in developers so as to form a resist pattern coating.

Examples of usable positive, energy-sensitive compositions include organic solvent-based positive photosensitive resin compositions, aqueous positive photosensitive resin compositions and like positive photosensitive resin compositions; and organic solvent-based positive thermosensitive resin compositions, aqueous positive thermosensitive resin compositions and like positive thermosensitive resin compositions.

Positive Photosensitive Composition

Examples of positive photosensitive compositions into which the conductive powder and like components are incorporated include visible light-sensitive compositions comprising a resin, a photoacid generator and a photosensitizer, and ultraviolet-sensitive compositions comprising a resin and a photoacid generator. In these compositions, the photoacid generator is decomposed by light and generates an acid, which then decomposes the resin and thereby alters the polarity, molecular weight and other properties of the resin. As a result, the compositions are rendered soluble in alkaline or acid aqueous developers. These compositions may contain, if necessary, another resin or like components to adjust the solubility in developers.

Specific examples of positive photosensitive resin compositions include compositions mainly comprising a resin in which a quinone diazide sulfonic acid is bonded to an acrylic resin or like base resin containing ion-forming group(s) via a sulfonic acid ester linkage, i.e., naphthoquinone diazide photosensitive compositions which undergo, when irradiated with light, a reaction to photolyze quinone diazide group(s) and to form indenecarboxylic acid via ketene; positive photosensitive compositions which form, when heated, a crosslinked coating insoluble in alkaline or acid developers and capable of becoming soluble in alkaline or acid developers when irradiated with light, owing to severance of the crosslinked structure by the photoacid generator which generates an acid when irradiated with light.

Examples of compositions mainly comprising a resin in which a quinone diazide sulfonic acid is bonded to a base resin containing ion-forming group(s) via a sulfonic acid ester linkage include those disclosed in Japanese Unexamined Patent Publications No. 1986-206293 and No. 1995-133449. Examples of positive photosensitive compositions which form, when heated, an insoluble crosslinked coating which is capable of becoming soluble in developers when irradiated with light owing to severance of the crosslinked structure include those disclosed in Japanese Unexamined Patent Publications No. 1994-295064, No. 1994-308733, No. 1994-313134, No. 1994-313135, No. 1994-313136 and No. 1995-146552.

When acidic group(s) is incorporated into the resin in the above compositions, the compositions can be neutralized with an amine or like basic compound and used as anionic aqueous resin compositions. When basic group(s) is incorporated into the resin, the compositions can be neutralized with an acid or like acidic compound and used as cationic aqueous resin compositions.

A typical example of an acidic group is a carboxyl group. A preferable carboxyl content is such that the resin has an acid value of about 10 to 700 mg KOH/g, in particular about 20 to 600 mg KOH/g. If the resin has an acid value less than about 10 mg KOH/g, the conductive coating will not be sufficiently removed with an alkaline developer, thus failing to form a high resolution pattern. On the other hand, if the resin has an acid value more than about 700 mg KOH/g, the conductive coating is excessively removed, thus failing to form a high resolution pattern. Therefore, an acid value outside the specified range is undesirable.

The photoacid generator is a compound that generates, when exposed to light, an acid, which acts as a catalyst to decompose the resin. Known photoacid generators are usable, which include, for example, sulfonium salts, ammonium salts, phosphonium salts, iodonium salts, selenium salts and like onium salts; iron-allene complexes, ruthenium-allene complexes, silanol-metal chelate complexes and like complexes; triazine compounds; diazide naphthoquinone compounds; sulfonic acid esters; sulfonic acid imide esters; sulfonyloxyimide compounds; and halogen compounds. Also usable are photoacid generators disclosed in Japanese Unexamined Patent Publication No. 1995-146552 and Japanese Patent Application No. 1997-289218. Among these photoacid generators, sulfonyloxyimide compounds and the like are preferred. Particularly preferred is “NAI-105” (a tradename for N-trifluoromethylsulfonyloxy-1,8-naphthylimide) manufactured by Midori Kagaku Co., Ltd.

The photoacid generator can be used as mixed with the resin or as bonded to the skeleton of the resin. The photoacid generator is used in a proportion of preferably about 0.1 to 40 parts by weight, in particular about 0.2 to 20 parts by weight, per 100 parts by weight of the resin.

The photosensitizer may be a known photosensitizing dye. Examples of known photosensitizing dyes include thioxanthene dyes, xanthene dyes, ketone dyes, thiopyrylium salt dyes, base styryl dyes, merocyanine dyes, coumarin dyes, cyanine dyes, acridine dyes, thiazine dyes, phenothiazine dyes, anthracene dyes, coronene dyes, benzanthracene dyes, perylene dyes, merocyanine dyes, fumarine dyes, borate dyes and like photosensitizing dyes. These dyes may be used either singly or in combination.

Coumarin photosensitizing dyes include, for example, 3-substituted coumarin dyes, 3,4-substituted coumarin dyes, ketocoumarin dyes and like photosensitizing dyes. A preferred coumarin photosensitizing dye is “NKX-1595” (a tradename for (10,12-Bebzithiazolyl)-2,3,6,7-tetrahydro-1,1,7,7-tetramethyl 1H,5H,11H-[1]benzopyrano[6,7,8-ij] quinolizin-11-one) manufactured by Nippon Kanko Shikiso.

Borate photosensitizing dyes include, for example, those disclosed in Japanese Unexamined Patent Publications No. 1993-241338, No. 1995-5685 and No. 1995-225474. Preferred borate photosensitizing dyes are dipyrromethene boron complex compounds.

The photosensitizer is preferably used in a proportion of about 0.1 to 40 parts by weight, in particular about 0.2 to 20 parts by weight, per 100 parts by weight of the resin.

Positive Thermosensitive Composition

Examples of positive thermosensitive compositions into which a conductive powder and like components are incorporated include known compositions such as positive thermosensitive resin compositions comprising a thermosensitive resin, an ether linkage-containing olefinic unsaturated compound and a thermal acid generator. Preferred is, for example, a positive thermosensitive resin compositions disclosed in Japanese Unexamined Patent Publication No. 2000-187326.

The composition disclosed in the publication is a positive thermosensitive resin composition comprising a thermosensitive resin, an ether linkage-containing olefinic unsaturated compound and a thermal acid generator, in which the thermosensitive resin is the following copolymer:

a copolymer having a structural unit represented by Formula (1)

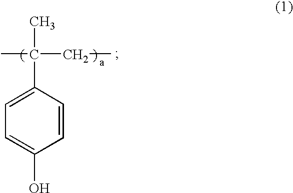

a structural unit represented by Formula (2)

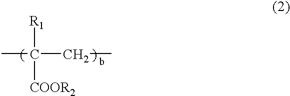

wherein R₁ is hydrogen or methyl, R₂ is C₁ to C₆ linear or branched unsubstituted alkyl or C₁ to C₆ linear or branched substituted alkyl; and a structural unit represented by Formula (3)

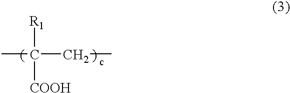

wherein R₁ is hydrogen or methyl; the molar proportions of the structural units being a=0.05 to 0.7, b=0.15 to 0.8 and c=0.01 to 0.5 and the sum of a, b and c being 1.

In the above copolymer, R₂ in the structural unit of Formula (2) is preferably C₁ to C₆ linear or branched unsubstituted alkyl or C₁ to C₆ linear or branched hydroxy-substituted alkyl.

R₂ in the structural unit of Formula (2) is preferably methyl, ethyl, n-propyl, isopropyl, n-butyl, isobutyl, sec-butyl or 2-hydroxyethyl.

It is preferable that the component for forming the structural unit of Formula (2) be an acrylic acid ester selected from methyl acrylate, ethyl acrylate, n-propyl acrylate, isopropyl acrylate, n-butyl acrylate, isobutyl acrylate, sec-butyl acrylate, 2-hydroxyethyl acrylate, methyl methacrylate, ethyl methacrylate, n-propyl methacrylate, isopropyl methacrylate, n-butyl methacrylate, isobutyl methacrylate, sec-butyl methacrylate and 2-hydroxyethyl methacrylate.

Further, it is preferable that the molar proportions of the structural units be a=0.20 to 0.45, b=0.25 to 0.70 and c=0.15 to 0.40, and that the sum of a, b and c be 1.

The copolymer has a weight average molecular weight (Mw) of usually 3,000 to 100,000, preferably 4,000 to 70,000, and has a molecular weight distribution (Mw/Mn) of usually 1.0 to 3.5, preferably 1.0 to 3.0. The weight average molecular weight and molecular weight distribution of the copolymer are those calculated as polystyrene and measured by gel permeation chromatography (GPC).

Since the above copolymer for use as the thermosensitive resin has acidic carboxyl groups, the copolymer can be neutralized with an amine or like basic compound and used as an anionic aqueous resin composition.

Usable as the ether linkage-containing olefinic unsaturated compound is a low-or high-molecular-weight compound containing, per molecule, about 1 to 4, preferably 2 to 4, unsaturated ether groups such as vinyl ether, 1-propenyl ether, 1-butenyl ether or the like.

Examples of vinyl ether groups include groups represented by the formula —R′—O—CH═CH₂ wherein R′ is ethylene, propylene, butylene or like C₁ to C₆ linear or branched alkylene.

Examples of the ether linkage-containing olefinic unsaturated compound include condensates of polyphenol compounds (e.g., bisphenol A, bisphenol F, bisphenol S, phenol resin or like polyphenol compounds) or polyols (e.g., ethylene glycol, propylene glycol, trimethylolpropane, trimethylolethane pentaerythritol) with halogenated alkyl vinyl ethers (e.g., chloroethyl vinyl ether). Particularly preferred are condensates of polyphenol compounds with halogenated alkyl vinyl ethers, from the viewpoints of etching resistance and precision of the resulting pattern. Also usable as the ether linkage-containing olefinic unsaturated compound is an ether linkage-containing olefinic polyurethane unsaturated compound containing, per molecule, about 1 to 4, preferably 2 to 4, unsaturated ether groups and at least one urethane bond.

It is suitable that the proportions of the copolymer and the ether linkage-containing olefinic unsaturated compound be 0.5 to 50 wt. % of the copolymer and 99.5 to 50 wt. % of the ether linkage-containing olefinic unsaturated compound, relative to the total weight of the two components.

The thermal acid generator is capable of being decomposed by irradiation with heat rays such as infrared rays to generate an acid. The generated acid acts as a catalyst which decomposes the resist coating crosslinked by a reaction between the copolymer and the olefinic unsaturated compound, and renders the coating developable. The thermal acid generator may be a known one.

Compounds usable as the thermal acid generator include, for example, ammonium salts, phosphonium salts, sulfonium salts, phosphonium salts, selenium salts, iodonium salts and like onium salts; aryl naphthoquinone diazide-4-sulfonates; diazonium compounds; halogen compounds; combinations of organic metals/organic halogens; benzoin esters and o-nitrobenzyl esters of strong acids such as toluenesulfonic acid; and N-hydroxyamides and N-hydroxyimide sulfonates disclosed in U.S. Pat. No. 4,371,605.

Other effective thermal acid generators include oligomers and polymers comprising appended anionic groups having an aromatic onium acid generator as the positive counter ion. Examples of such polymers include those disclosed in U.S. Pat. No. 4,661,429.

Also usable as the thermal acid generator is hexafluoroantimonic acid-3-(9-anthracenyl)propyl-diphenylsulfonium. In this compound, anthracene and a sulfonium salt are linked to each other with a chain consisting of three carbon atoms. Further, diphenyliodonium tosylate, benzoin tosylate, triarylsulfonium hexafluoroantimonate and N-(trifluoromethylsulfonyloxy)-1,8-naphthalenedicarboxyimide are also usable.

Other examples of the thermal acid generator include iron-allene complexes, ruthenium-allene complexes, silanol-metal chelate complexes, triazine compounds, diazide naphthoquinone compounds and sulfonic acid esters, sulfonic acid imide esters.

Preferably, the thermal acid generator is used in an amount of about 0.1 to 40 parts by weight, in particular about 0.2 to 20 parts by weight, per 100 parts by weight of the total amount of the copolymer and the olefinic unsaturated compound.

Processes for Preparation and Application of the Positive, Energy-Sensitive Paste Composition

The positive, energy-sensitive paste composition for use in the invention can be prepared usually by adding a conductive powder and optionally a heat-fusible inorganic powder to any of the above positive, energy-sensitive compositions to form a paste composition.

When necessary, coloring agents, fillers, additives or the like can be further added to the paste composition. Examples of coloring agents include carbon black and like coloring pigments and dyes.

When the paste composition is organic solvent-based, the composition can be prepared by dissolving or dispersing the components in an organic solvent to form a paste. Usable organic solvents include ketones, esters, ethers, cellosolves, aromatic hydrocarbons, alcohols, halogenated hydrocarbons and the like. The paste composition has a solid content of preferably 10 to 90 wt. %, more preferably 50 to 80 wt. %.

When the paste composition is aqueous, the composition can be prepared by dissolving or dispersing the components in water to form a paste. The positive photosensitive resin composition or thermosensitive resin composition can be made water-soluble or water-dispersible usually by neutralizing carboxyl groups or amino groups of the resin contained in the composition, with an alkali or acid. The paste composition has a solid content of preferably 10 to 90 wt. %, more preferably 50 to 80 wt. %.

The positive, energy-sensitive paste composition can be applied to a substrate by a process such as roller coating, roll coater coating, spin coater coating, curtain roll coater coating, spray coating, electrostatic coating, dip coating, silk printing or spin coating.

Then, the composition is optionally set, and dried at about 50 to 130° C. to form a coating of the paste composition.

The positive, energy-sensitive paste composition may be made into a dry film by applying the composition to a surface of release film of polyethylene terephthalate or the like, followed by drying at room temperature or baking (for example, at 120° C. for 10 minutes) to form an uncured or cured layer of the paste composition. This dry film can be also used for forming a pattern.

Further, the positive, energy-sensitive paste composition may be molded and dried to obtain a molded article which can be used as a photosensitive substrate. When the molded article has a flat shape, the thickness of the article is preferably about 100 μm to about 10 mm, in particular about 200 μm to about 5 mm.

Method of Forming a Conductive Pattern

The method of forming a conductive pattern (a) of the invention comprises the steps of:

(1a) applying a positive, energy-sensitive paste composition containing a conductive powder to a substrate, followed by drying, to form a positive, energy-sensitive coating;

(2a) irradiating the coating with active energy rays or heat rays directly or through a mask so as to obtain a desired pattern; and

(3a) removing the irradiated part of the coating by development to form a conductive pattern coating.

In Step (1a), a positive, energy-sensitive paste composition containing a conductive powder is applied to a substrate and dried to form a positive, energy-sensitive coating.

The positive, energy-sensitive paste composition may be an aqueous or organic solvent-based liquid composition containing a conductive powder and optionally a heat-fusible inorganic powder.

The substrate is not limited and can be selected as desired. Usable substrates include, for example, glass substrates, conductive metal-deposited substrates, ceramic substrate, plastic substrates and the like. Examples of conductive metal-deposited substrates include ITO substrates, aluminium plates and chromium plates.

The paste composition can be applied by, for example, roller coating, roll coater coating, spin coater coating, curtain roll coater coating, spray coating, electrostatic coating, dip coating, silk printing, spin coating or like process.

The applied composition is optionally set and then dried by heating preferably at 50 to 130° C., in particular 80 to 120° C., preferably for 5 to 60 minutes, in particular 10 to 30 minutes. In this manner, a positive, energy-sensitive coating is formed.

A preferred thickness of the positive, energy-sensitive coating varies according to the type of the substrate and the coating process. When the composition is used for coating black matrixes or applied by printing, the thickness of the coating is preferably about 1 to 100 μm, in particular about 2 to 80 μm.

In Step (2a), the coating formed in Step (1a) is irradiated with active energy rays or heat rays directly or through a mask so as to obtain a desired pattern.

Light sources of the active energy rays are not limited and include, for example, extra-high pressure, high-pressure, medium-pressure or low-pressure mercury lamps, chemical lamps, carbon arc lamps, xenon lamps, metal halide lamps and tungsten lamps. Also usable are various lasers that produce an oscillating beam in the visible region, such as argon lasers (488 nm) and YAG-SHG lasers (532 nm). Moreover, lasers that produce an oscillating beam in the ultraviolet region, such as UV lasers (351 to 364 nm), may be used.

The amount of the active energy rays is preferably about 10⁻¹ to 10³ mJ/cm², more preferably 1 to 10² mJ/cm².

The heat rays may be, for example, infrared laser rays. The amount of the infrared rays is preferably about 10 to 100,000 mJ/cm², more preferably about 100 to 50,000 mJ/cm².

In Step (3a), the irradiated part of the coating is removed by development to form a conductive pattern coating.

The development is carried out using an alkaline developer in the case where the resin in the coating contains acid group(s). When the resin contains basic group(s), an acid developer can be used. When the resin contains hydrophilic group(s), water can be used as a developer. When the resin is soluble or dispersible in organic solvents, an organic solvent can be used as a developer.

Examples of alkaline developers include aqueous solutions of monomethylamine, dimethylamine, trimethylamine, monoethylamine, diethylamine, triethylamine, monoisopropylamine, diisopropylamine, triisopropylamine, monobutylamine, dibutylamine, monoethanolamine, diethanolamine, triethanolamine, dimethylaminoethanol, diethylaminoethanol, ammonia, caustic soda, caustic potash, sodium metasilicate, potassium metasilicate, sodium carbonate, tetraethylammonium hydroxide and the like.

Examples of acid developers include aqueous solutions of formic acid, crotonic acid, acetic acid, propionic acid, lactic acid, hydrochloric acid, sulfuric acid, nitric acid, phosphoric acid and the like.

It is preferable that the concentration of the alkaline or acid substance in the developer be about 0.05 to 10 wt. %.

Usable organic solvents include, for example, hexane, heptane, octane, toluene, xylene, dichloromethane, chloroform, carbon tetrachloride, trichloroethylene and like hydrocarbon solvents; methanol, ethanol, propanol, butanol and like alcohol solvents; diethyl ether, dipropyl ether, dibutyl ether, ethyl vinyl ether, dioxane, propylene oxide, tetrahydrofuran, cellosolve, methyl cellosolve, butyl cellosolve, methyl carbitol, diethylene glycol monoethyl ether and like ether solvents; acetone, methyl ethyl ketone, methyl isobutyl ketone, isophorone, cyclohexanone and like ketone solvents; methyl acetate, ethyl acetate, propyl acetate, butyl acetate and like ester solvents; and pyridine, formamide, N,N-dimethylformamide and other solvents.

The development can be suitably effected by spraying with or immersion in a developer at about 10 to 80° C., preferably about 15 to 50° C., for about 10 seconds to about 20 minutes, preferably about 15 seconds to about 15 minutes.

The method of forming a conductive pattern (b) of the present invention comprises the steps of:

(1b) applying a positive, energy-sensitive paste composition containing a conductive powder to a surface of release film, followed by drying, to form a dry film having a positive, energy-sensitive layer;

(2b) superimposing the dry film onto a substrate in such a manner that the surface of the positive, energy-sensitive layer is in contact with the substrate, to form a positive, energy-sensitive coating, and then peeling off the release film;

(3b) irradiating the coating with active energy rays or heat rays directly or through a mask so as to obtain a desired pattern; and

(4b) removing the irradiated part of the coating by development to form a conductive pattern coating.

In Step (1b), a positive, energy-sensitive paste composition containing a conductive powder is applied to a surface of release film and dried to obtain a film having a positive, energy-sensitive coating.

As the release film, a film conventionally used in dry films can be employed. Specific examples of usable release films include those made of polyethylene terephthalate, polypropylene, polyethylene, polyvinyl alcohol, polyvinyl chloride, polyacrylic acid ester or like material. These films are preferably transparent so that light irradiation can be performed through the films. A suitable thickness of the release film is about 5 to 200 μm, in particular 10 to 50 μm.

The applied composition is dried preferably at 50 to 130° C., in particular 80 to 120° C., preferably for 5 to 60 minutes, in particular 10 to 30 minutes.

In Step (2b), the film obtained in Step (1b) is superimposed onto a substrate in such a manner that the surface of the positive, energy-sensitive layer is in contact with the substrate, to form a positive, energy-sensitive coating, and then the release film is peeled off.

The positive, energy-sensitive coating is preferably about 1 to 100 μm thick, in particular about 2 to 80 μm thick.

The Steps (3b) and (4b) can be performed in the same manner as Steps (2a) and (3a).

The method of forming a conductive pattern (c) of the invention comprises the steps of:

(1c) applying a positive, energy-sensitive paste composition containing a conductive powder to a surface of release film, followed by drying, to form a dry film having a positive, energy-sensitive layer;

(2c) superimposing the dry film onto the substrate in such a manner that the surface of the positive, energy-sensitive layer is in contact with the substrate to form a positive, energy-sensitive coating;

(3c) irradiating the coating with active energy rays or heat rays through the release film with or without a mask so as to obtain a desired pattern; and

(4c) peeling off the release film and then removing the irradiated part of the coating by development to form a conductive pattern coating.

The method (c) is the same as the method (b) except that the release film is peeled off after forming a pattern coating.

In the method of forming a conductive pattern (a), (b) or (c), it is preferable that the positive, energy-sensitive paste composition contain a conductive powder and a heat-fusible inorganic powder and that calcination be carried out after Step (3a), (4b) or (4c). The calcination is preferably carried out, for example, at about 300 to 800° C. for about 20 to 60 minutes.

The calcination evaporates the resin component from the coating, and makes it possible to form a strongly adhering conductive pattern coating, as a result of fusion, melting or the like of the remaining conductive powder and inorganic powder such as a glass frit.

It is desirable that the calcined conductive pattern coating have a volume resistivity not greater than 10⁻⁴Ω108 cm.

The conductive pattern coating formed by any of the methods of the invention can be used as, for example, a conductive pattern for black matrixes, a conductive pattern for color filters, a conductive pattern for display panels, or a conductive pattern on plastic substrates, build-up substrates or the like.

Further, a combination of the methods of the invention is capable of forming, for example, a pattern of a bus electrode or address electrode in a plasma display, in which a transparent electrode pattern layer is wholly or partially laminated with a black conductive coating layer or a silver conductive coating layer.

### BRIEF DESCRIPTION OF DRAWINGS

FIG. 1 is a schematic cross-sectional view of a pattern coating obtained by the method for forming a conductive pattern according to the present invention. FIG. 2 is a schematic cross-sectional view of a pattern coating obtained by a conventional method of forming a conductive pattern. In FIGS. 1 and 2, 1 indicates a substrate; 2, a conductive pattern coating before calcination; and 3, a conductive pattern coating after calcination.

### BEST MODE FOR CARRYING OUT THE INVENTION

The following Production Examples and Examples are provided to illustrate the present invention in further detail. In these examples, parts and percentages are all by weight.

### Production Example 1

Production of Aqueous Positive photosensitive Anionic Paste Composition A

A mixture of 200 parts of tetrahydrofuran, 65 parts of p-hydroxystyrene, 28 parts of n-butyl acrylate, 11 parts of acrylic acid and 3 parts of azobisisobutyronitrile was reacted at 100° C. for 2 hours. The reaction product was poured into 1500 cc of toluene as a solvent to settle and separate the reaction product. The reaction product was dried at 60° C., giving a photosensitive resin having a molecular weight of about 5,200 and a hydroxyphenyl content of 4.6 moles/kg. Then, to 100 parts of the resin was added 100 parts (based on solids) of a mixture which consisted of 60 parts of a divinyl ether compound (a condensate of 1 mole of a bisphenol compound and 2 moles of 2-chloroethyl vinyl ether), 10 parts of “NAI-105” (a tradename of Midori Kagaku Co., Ltd., a photoacid generator) and 1.5 parts of “NKX-1595” (a tradename of Nipon Kanko Shikiso, a coumarin photosensitizing dye), giving a photosensitive liquid. 7 parts of triethylamine was added to the photosensitive liquid, and the resulting mixture was stirred and dispersed in deionized water to obtain an aqueous resin dispersion (solid content: 15%).

Per 100 parts by weight of the solids of the aqueous resin dispersion were added 660 parts of a silver powder having an average particle size of 1 μm and 33 parts of a glass frit (a powder consisting of 60% of PbO, 20% of B₂O₃, 15% of SiO₂ and 5% Al₂O₃ and having an average particle size of 1.6 μm). The resulting mixture was placed in a pebble mill to disperse the silver powder and glass frit. In this manner, photosensitive silver paste composition A was obtained.

### Production Example 2

Production of organic solvent-based positive photosensitive paste composition B

A photosensitive liquid prepared in the same manner as in Production Example 1 was dissolved in diethylene glycol dimethyl ether as a solvent, to obtain an organic solvent resin solution (solid content: 30%).

Per 100 parts of the solids of the solution were added 660 parts of a silver powder having an average particle size of 1 μm and 33 parts of a glass frit (a powder consisting of 60% of PbO, 20% of B₂O₃, 15% of SiO₂ and 5% of Al₂O₃ and having an average particle size of 1.6 μm). The resulting mixture was placed in a pebble mill to disperse the silver powder and glass frit. In this manner, photosensitive silver paste composition B was obtained.

### Production Example 3

Production of Organic Solvent-Based Positive Thermosensitive Paste Composition C

200 ml of tetrahydrofuran was placed in a four-necked flask having an internal volume of 1,000 ml and equipped with a stirrer, a thermometer, a condenser tube and a dropping funnel with an internal volume of 500 ml. The tetrahydrofuran was refluxed with stirring by raising the external temperature to 80° C. with a water bath.

Separately, in a 1,000 ml Erlenmeyer flask were placed 134.2 g (1.00 mole) of 4-(1-methylethenyl)phenol purified by crystallization from a 2-ethylhexanol solution, 143.8 g (1.67 moles) of methyl acrylate purified by distillation, 48.3 g (0.67 moles) of acrylic acid, 16.4 g (0.10 moles) of azobisisobutyronitrile as a radical polymerization initiator, and 200 ml of tetrahydrofuran as a solvent. The resulting mixture was stirred to give a monomer solution.

The monomer solution was placed in a dropping funnel, and dropped into the four-necked flask at a speed that allowed the content of the flask to continue to be refluxed. The internal temperature of the flask was 72° C. at the initial stage of the polymerization, but rose during the polymerization and reached 80° C. eight hours after the start of the polymerization. While continuing stirring, the water bath was removed and the mixture in the flask was cooled to room temperature (25° C.) over 2 hours. Thereafter, the polymerization mixture was added to 2 liters of n-hexane in a 5 liter beaker to settle the produced polymer. The settled polymer was separated by filtration and dissolved in 400 ml of tetrahydrofuran. The solution was then added to 2 liters of n-hexane to precipitate solids. This cycle of separation by filtration and precipitation was carried out two more times. After the last separation by filtration, the separated polymer was dried at a reduced pressure of 100 mm Hg and at 100° C. for 2 hours, giving 320.4 g of a white copolymer.

¹H-NMR analysis, ¹³C-NMR analysis and elemental analysis revealed that, in the obtained copolymer, the proportions of the structural units represented by Formulas (1), (2) and (3) are a=0.34, b=0.48 and c=0.18, which were substantially equal to the proportions of the starting materials used. Further, GPC analysis using polystyrene as the standard showed that the copolymer had a weight average molecular weight (Mw) of 10,000, and a molecular weight distribution (Mw/Mn) of 1.94.

The copolymer was soluble in both diethylene glycol dimethyl ether and 2-heptanone to a concentration of 50%. The copolymer was dissolved in diethylene glycol dimethyl ether to a concentration of 10%, and applied to a quartz plate to a dry thickness of 1 μm using a spin coater, and heated at 120° C. for 10 minutes to form a coating. The coating had a transmittance of at least 98% at 350 nm as measured with a visible spectrophotometer.

The coating had a glass transition point of 125° C. as measured with a differential scanning calorimeter. Further, the coating was stable at 200° C. or higher when tested for thermal stability using a differential thermobalance.

100 g (based on solids) of the copolymer, 60 g of a divinyl ether compound (a condensate of 1 mole of a bisphenol compound and 2 moles of 2-chloroethyl vinyl ether) and 10 g of N-(trifluoromethylsulfonyloxy)-1, 8-naphthalenedicarboxyimide as a thermal acid generator were dissolved in diethylene glycol dimethyl ether as a solvent, to obtain a 50 wt. % solution of a thermosensitive resin composition.

Per 100 parts of the solids of the solution of the composition were added 660 parts of a silver powder having an average particle size of 1 μm and 33 parts of a glass frit (a powder consisting of 60% of PbO, 20% of B₂O₃, 15% of SiO₂ and 5% of Al₂O₃, and having an average particle size of 1.6 μm). The resulting mixture was placed in a pebble mill to disperse the silver powder and glass frit, giving thermosensitive silver paste composition C.

### Production Example 4

Production of positive dry film (I)

Paste composition A was applied to one side of a 50 μm thick polyethylene terephthalate film to a dry thickness of 20 μm by roller coating, set and dried by heating at 120° C. for 10 minutes, giving positive dry film (I).

### Production Example 5

Production of Positive Dry Film (II)

Paste composition B was applied to one side of a 50 μm thick polyethylene terephthalate film to a dry thickness of 20 μm by roller coating, set and dried by heating at 120° C. for 10 minutes, giving positive dry film (II).

### EXAMPLE 1

Paste composition A was applied to the whole surface of a transparent glass plate substrate (200×200×1.1 mm) having on the surface stripe-patterned transparent electrodes of line(pattern width)/space=100 μm /20 μm, using a spin coater. The composition was then preheated at 120° C. for 10 minutes, to form about 5 μm thick positive photosensitive conductive coating A.

Subsequently, the surface of the conductive coating was exposed to direct irradiation with 70 mj/cm² of argon laser beam (oscillating at 488 nm) to form a pattern of line/space=50 μm/100 μm, so that the conductive coating would be made into a desired electrode pattern when developed. The coating was then heated at 120° C. for 10 minutes and developed by immersion in alkaline developer a (a 0.25% aqueous solution of sodium carbonate) at 25° C. for 60 seconds to remove the irradiated part.

The resulting coating was allowed to stand at 450° C. for 30 minutes and calcined at 575° C. for 30 minutes, giving a substrate having a conductive pattern. In the conductive pattern, the lines remained well and the spaces were developed well. The conductive pattern after calcination had a good line shape. Also, the conductive pattern coating (electrode membrane) had a desirable volume resistivity not greater than 10⁻⁴Ω•cm.

### EXAMPLE 2

Paste composition B was applied to the same glass plate substrate as used in Example 1 and dried in the same manner as in Example 1, to form positive photosensitive conductive coating B.

The surface of the conductive coating was exposed to direct irradiation with 20 mj/cm² of argon laser beam (oscillating at 488 nm) to form a pattern of line/space=50 μm/100 μm, so that the conductive coating would be made into a desired electrode pattern when developed. The coating was then heated at 120° C. for 10 minutes and developed by immersion in alkaline developer a at 25° C. for 60 seconds to remove the irradiated part.

The resulting coating was allowed to stand at 450° C. for 30 minutes and calcined at 575° C. for 30 minutes, giving a substrate having a conductive pattern. In the conductive pattern, the lines remained well and the spaces were developed well. The conductive pattern after calcination had a good line shape. Also, the conductive pattern coating (electrode membrane) had a desirable volume resistivity not greater than 10⁻⁴Ω•cm.

### EXAMPLE 3

Dry film (I) was superimposed onto the same glass plate substrate as used in Example 1 in such a manner that the surface of the photosensitive layer was in contact with the substrate to form a positive photosensitive conductive coating. Then, the polyethylene terephthalate film was peeled off.

The surface of the conductive coating was exposed to direct irradiation with 70 mj/cm² of argon laser beam (oscillating at 488 nm) to form a pattern of line/space=50 μm/100 μm, so that the conductive coating would be made into a desired electrode pattern when developed. The coating was then heated at 120° C. for 10 minutes and developed by immersion in alkaline developer a at 25° C. for 60 seconds to remove the irradiated part.

The resulting coating was allowed to stand at 450° C. for 30 minutes and calcined at 575° C. for 30 minutes, giving a substrate having a conductive pattern. In the conductive pattern, the lines remained well and the spaces were developed well. The conductive pattern after calcination had a good line shape. Also, the conductive pattern coating (electrode membrane) had a desirable volume resistivity not greater than 10⁻⁴Ω•cm.

### EXAMPLE 4

Dry film (II) was superimposed onto the same glass plate substrate as used in Example 1 so that the surface of the photosensitive layer was in contact with the substrate, to form a positive photosensitive conductive coating. Then, the polyethylene terephthalate film was peeled off.

The surface of the conductive coating was exposed to direct irradiation with 20 mj/cm² of argon laser beam (oscillating at 488 nm) to form a pattern of line/space=50 μm/100 μm, so that the conductive coating would be made into a desired electrode pattern when developed. The coating was then heated at 120° C. for 10 minutes and developed by immersion in alkaline developer a at 25° C. for 60 seconds to remove the irradiated part.

The resulting coating was allowed to stand at 450° C. for 30 minutes and calcined at 575° C. for 30 minutes, giving a substrate having a conductive pattern. In the conductive pattern, the lines remained well and the spaces were developed well. The conductive pattern after calcination had a good line shape. Also, the conductive pattern coating (electrode membrane) formed had a desirable volume resistivity not greater than 10⁻⁴Ω•cm.

### EXAMPLE 5

Paste composition C was applied to the same glass plate substrate as used in Example 1 and dried in the same manner as in Example 1, to form positive thermosensitive conductive coating C.

The surface of the conductive coating was exposed to direct irradiation with 20,000 mj/cm² of infrared laser beam to form a pattern of line/space=50 μm/100 μm, so that the conductive coating would be made into a desired electrode pattern when developed. The coating was then heated at 120° C. for 10 minutes and developed by immersion in alkaline developer a at 25° C. for 60 seconds to remove the irradiated part.

The resulting coating was allowed to stand at 450° C. for 30 minutes and calcined at 575° C. for 30 minutes, giving a substrate having a conductive pattern. In the conductive pattern, the lines remained well and the spaces were developed well. The conductive pattern after calcination had a good line shape. Also, the conductive pattern coating (electrode membrane) had a desirable volume resistivity not greater than 10⁻⁴Ω•cm.

The method of the invention has the following remarkable advantages.

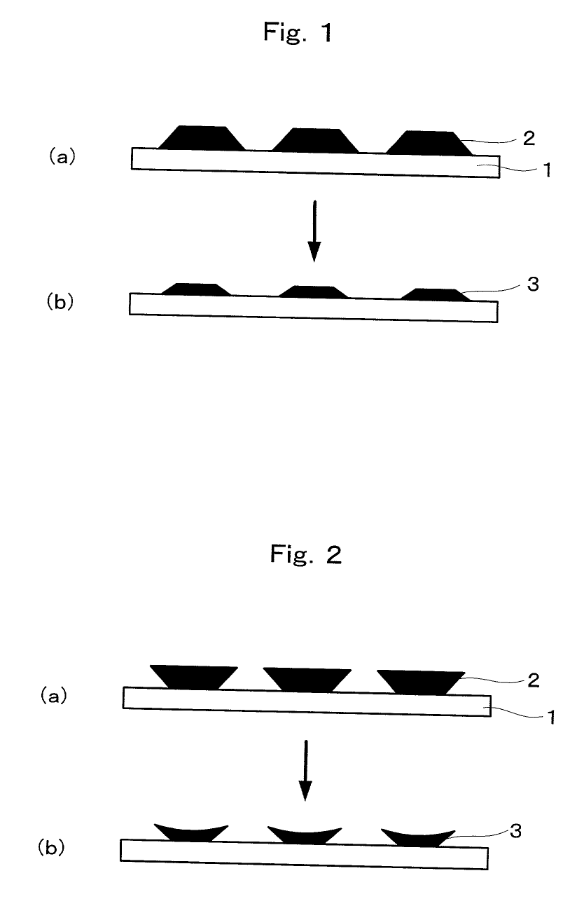

(1) In the method of the invention, a conductive coating formed from a positive, energy-sensitive paste composition is irradiated with energy rays so as to form a desired conductive pattern, and the irradiated part is decomposed and developed to form a conductive pattern. The inner portion of the conductive coating, which is closer to the substrate, is more difficult to dissolve and remove with a developer than the surface portion of the coating. As a result, the developed conductive pattern coating has a cross section as shown in FIG. 1 (a), and when calcined, has a cross section as shown in FIG. 1 (b), so that the resulting wiring circuit or the like has high precision.

(2) Since a positive paste composition is used, the method of the invention is free from curing inhibition due to oxygen, unlike a method using a negative paste composition. Therefore, the conductive coating is highly sensitive to energy rays, and thus is capable of forming a sharp pattern.

(3) Since the paste composition used in the method of the invention comprises a large proportion of a conductive powder and optionally a heat-fusible inorganic powder, the proportion of resin in the conductive coating is small. Therefore, the coating releases a reduced amount of gas and thus causes no problem of environmental pollution.

1. A method of forming a conductive pattern, comprising the steps of:
(1a) applying a positive, energy-sensitive paste composition containing a conductive powder to a substrate, followed by drying, to form a positive, energy-sensitive coating;
(2a) irradiating the coating with active energy rays or heat rays directly or through a mask so as to obtain a desired pattern; and
(3a) removing the irradiated part of the coating by development to form a conductive pattern coating.

2. A method according to claim 1, wherein the positive, energy-sensitive paste composition is a positive, visible light-sensitive paste composition.

3. A method according to claim 1, wherein the positive, energy-sensitive paste composition is a positive, ultraviolet-sensitive paste composition.

4. A method according to claim 1, wherein the positive, energy-sensitive paste composition is a positive thermosensitive paste composition.

5. A method according to claim 1, wherein the positive, energy-sensitive paste composition further contains a heat-fusible inorganic powder and wherein calcination is carried out after Step (3a).

6. A method according to claim 5, wherein the heat-fusible inorganic powder is a glass frit.

7. A method of forming a conductive pattern, comprising the steps of:
(1b) applying a positive, energy-sensitive paste composition containing a conductive powder to a surface of release film, followed by drying, to form a dry film having a positive, energy-sensitive layer;
(2b) superimposing the dry film onto a substrate in such a manner that the surface of the positive, energy-sensitive layer is in contact with the substrate, to form a positive, energy-sensitive coating, and then peeling off the release film;
(3b) irradiating the coating with active energy rays or heat rays directly or through a mask so as to obtain a desired pattern; and
(4b) removing the irradiated part of the coating by development to form a conductive pattern coating.

8. A method according to claim 7, wherein the positive, energy-sensitive paste composition is a positive, visible light-sensitive paste composition.

9. A method according to claim 7, wherein the positive, energy-sensitive paste composition is a positive, ultraviolet-sensitive paste composition.

10. A method according to claim 7, wherein the positive, energy-sensitive paste composition is a positive thermosensitive paste composition.

11. A method according to claim 7, wherein the positive, energy-sensitive paste composition further contains a heat-fusible inorganic powder and wherein calcination is carried out after Step (4b).

12. A method according to claim 11, wherein the heat-fusible inorganic powder is a glass frit.

13. A method of forming a conductive pattern, comprising the steps of:
(1c) applying a positive, energy-sensitive paste composition containing a conductive powder to a surface of release film, followed by drying, to form a dry film having a positive, energy-sensitive layer;
(2c) superimposing the dry film onto a substrate in such a manner that the surface of the positive, energy-sensitive layer is in contact with the substrate, to form a positive, energy-sensitive coating;
(3c) irradiating the coating with active energy rays or heat rays through the release film with or without a mask so as to obtain a desired pattern; and
(4c) peeling off the release film, and removing the irradiated part of the coating by development to form a conductive pattern coating.

14. A method according to claim 13, wherein the positive, energy-sensitive paste composition is a positive, visible light-sensitive paste composition.

15. A method according to claim 13, wherein the positive, energy-sensitive paste composition is a positive, ultraviolet-sensitive paste composition.

16. A method according to claim 13, wherein the positive, energy-sensitive paste composition is a positive, thermosensitive paste composition.

17. A method according to claim 13, wherein the positive, energy-sensitive paste composition further contains a heat-fusible inorganic powder and wherein calcination is carried out after Step (4c).

18. A method according to claim 17, wherein the heat-fusible inorganic powder is a glass frit.
